(19) United States
(12) Patent Application Publication
(10) Pub. No.: US 2010/0261823 A1
(43) Pub. Date: Oct. 14, 2010

(54) FLAKES COMPRISING PYROGENICALLY PREPARED SILICON DIOXIDE

(75) Inventors: Florian Felix Kneisel, Essen (DE); Ralph Hofmann, Buchen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Degussa GmbH, Essen (DE)

(21) Appl. No.: 12/742,518

(22) PCT Filed: Nov. 18, 2008
(86) PCT No.: PCT/EP2008/065775

§ 371 Date: May 12, 2010

(30) Foreign Application Priority Data
Dec. 12, 2007 (DE) 102007059860.4

(51) Int. Cl. C04B 14/04; C08K 5/5419

(52) U.S. Cl. 524/261; 106/490

(57) ABSTRACT

Flakes comprising pyrogenically prepared silicon dioxide were rendered water repellent after compacting. They can be used in natural rubber and synthetic rubber production.

The invention relates to flakes comprising pyrogenically prepared silicon dioxide, a process for their production and use thereof.

It is known that flakes can be produced from pyrogenically prepared silicon dioxide by partly dearating pyrogenically prepared silicon dioxide, which is present as a loose heap of nanoscale, highly agglomerated particles, by reduced atmospheric pressure, mechanically precompacting said silicon dioxide and finally compacting it by pressing to give flakes. These flakes can then be crushed and the fragments optionally classified (EP 1 813 574 A1).

Hydrophilic and also hydrophobic, pyrogenically prepared silicon dioxide particles can be used as starting materials. The silicon dioxide may have been rendered hydrophobic inter alia with silazanes of the type

R′R₂Si—N—SiR₂R′H.

A disadvantage of the known process is found in the case of particles which have a high specific surface area, measured by nitrogen adsorption (BET), and simultaneously a high hydrophobicity, measured by wetting with methanol-water mixtures of graded methanol content (Corning Glass), in that these particles have a very high fluidity, so that the process according to EP 1 813 574 A1 is truly uneconomical for compacting such particles.

Fluidity is to be understood as meaning that the loose heap which is formed by agglomeration of highly aggregated particles and consists of more than 95 per cent of its volume of air and only of less than 5 per cent of its volume of solid is orthogonally deflected under the action of a compressive force applied from outside, it being possible for said heap also to escape through very small gaps in the same manner as a low-viscosity liquid. The flakes of hydrophobic silicon dioxides can therefore be produced only with difficulty by the process described in EP 1 813 574 A1.

In many cases, very high pressures, very long pressure dwell times and often numerous compacting cycles have to be implemented in the compacting of hydrophobic silicon dioxides. Silicon dioxides which both consist of very fine particles and are additionally strongly hydrophobic therefore cannot be compressed economically by the known process to give compact materials.

It was therefore the object to prepare hydrophobic flakes comprising pyrogenically prepared silicon dioxide by a process which does not have these disadvantages.

The invention relates to flakes comprising pyrogenically prepared silicon dioxide which are characterized in that the flakes are rendered water repellent by compacting.

The imparting of water repellency can be carried out using one or more compounds from the following group:
a) Organosilanes of the type (RO)₃Si(CₙH₂ₙ₊₁) and (RO)₃Si(CₙH₂ₙ₋₁)
   R=alkyl, such as, for example, methyl-, ethyl-, n-propyl-, isopropyl-, butyl- n=1-20
b) Organosilanes of the type R′ₓ(RO)_{y}Si(CₙH₂ₙ₊₁) and
   R′ₓ(RO)_{y}Si(CₙH₂ₙ₋₁)
   R=alkyl, such as, for example, methyl-, ethyl-, n-propyl-, isopropyl-, butyl-
   R′=alkyl, such as, for example, methyl-, ethyl-, n-propyl-, isopropyl-, butyl-
   R′=cycloalkyl
   n=1-20
   x+y=3
   x=1.2
   y=1.2
c) Haloorganosilanes of the type X₃Si (CₙH₂ₙ₊₁) and
   X₃Si (CₙH₂ₙ₋₁)
   X═Cl, Br
   n=1-20
d) Haloorganosilanes of the type X₂(R′)Si(CₙH₂ₙ₊₁) and
   X₂(R′)Si(CₙH₂ₙ₋₁)
   X═Cl, Br
   R′=alkyl, such as, for example, methyl-, ethyl-, n-propyl-, isopropyl-, butyl-
   R′=cycloalkyl
   n=1-20
e) Haloorganosilanes of the type X(R′)₂Si (CₙH₂ₙ₊₁) and
   X(R′)₂Si(CₙH₂ₙ₋₁)
   X═Cl, Br
   R′=alkyl, such as, for example, methyl-, ethyl-, n-propyl-, isopropyl-, butyl-
   R′=cycloalkyl
   n=1-20
f) Organosilanes of the type (RO)₃Si(CH₂)ₘ—R′
   R=alkyl, such as methyl-, ethyl-, propyl-
   m=0.1-20
   R′=methyl-, aryl (for example —C₆H₅, substituted phenyl radicals)
      —C₄F₉, OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      —OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃
      —Sₓ—(CH₂)₃Si(OR)₃, where X=1 to 10 and
   R may be alkyl, such as methyl-, ethyl-, propyl-,
      butyl-
      —SH
      —NR′R″R′″(R′=alkyl, aryl; R″═H, alkyl, aryl; R′″═H, alkyl, aryl, benzyl, C₂H₄NR″″R′″″ with R″″=A, alkyl and R′″″=H, alkyl)
g) Organosilanes of the type (R″)ₓ(RO)_{y}Si(CH₂)ₘ—R′
R″=alkyl x+y=2=cycloalkyl x=1.2
   y=1.2
   m=0.1 to 20
   R′=methyl-, aryl (for example —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃
      —Sₓ—(CH₂)₃Si(OR)₃, where X=1 to 10 and R may be methyl-, ethyl-, propyl-, butyl-
      —SH
      —NR′R″R′″(R′=alkyl, aryl; R″═H, alkyl, aryl; R′″═H, alkyl, aryl, benzyl, C₂H₄NR″″R′″″ with R″″=A, alkyl and R═H, alkyl)
h) Haloorganosilanes of the type X₃Si(CH₂)ₘ—R′
   X═Cl, Br
   m=0.1-20
   R′=methyl-, aryl (for example —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂,
      —NH—CH₂—CH₂—NH₂
      —N—(CH₂—CH₂—NH₂)₂
      —OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃
      —Sₓ—(CH₂)₃Si(OR)₃, where X=1 to 10 and
      R may be methyl-, ethyl-, propyl-, butyl-
      —SH
i) Haloorganosilanes of the type (R)X₂Si(CH₂)ₘ—R′
   X═Cl, Br
   R=alkyl, such as methyl-, ethyl-, propyl-
   m=0.1-20
   R′=methyl-, aryl (for example —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      —OOC(CH₃)C═CH₂
      —OCH₂—CH(O) CH₂
      —NH—CO—N—CO—(CH₂)₅
      —NH—COO—CH₃, —NH—COO—CH₂—CH₃, —NH—(CH₂)₃Si(OR)₃,
      where R may be methyl-, ethyl-, propyl-, butyl-
      —Sₓ—(CH₂)₃Si(OR)₃, where R may be methyl-, ethyl-, propyl-, butyl- and X may be 1 to 10
      —SH
j) Haloorganosilanes of the type (R)₂X Si(CH₂)ₘR′
   X═Cl, Br
   R=alkyl, such as methyl-, ethyl-, propyl-, butyl-
   m=0.1-20
   R′=methyl-, aryl (e.g. —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      —OOC(CH₃)C═CH₂
      —OCH₂—CH(O) CH₂
      —NH—CO—N—CO —(CH₂)₅
      —NH—COO—CH₃, —NH—COO—CH₂—CH₃, —NH—(CH₂)₃Si(OR)₃
      —Sₓ—(CH₂)₃Si(OR)₃, where X=1 to 10 and
      R may be methyl-, ethyl-, propyl-, butyl-
      —SH
k) Silazanes of the type

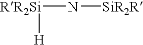

R=alkyl
R′=alkyl, vinyl
1) Cyclic polysiloxanes of the type D 3, D 4, D 5, where D 3, D 4 and D 5 are understood as meaning cyclic polysiloxanes having 3,4 or 5 units of the type —O—Si(CH₃)₂—, e.g. octamethylcyclotetrasiloxane=D 4

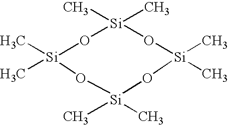

m) Polysiloxanes or silicone oils of the type

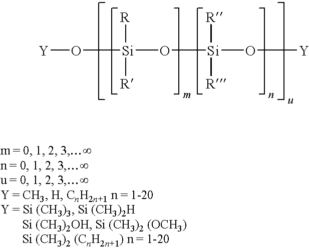

R=alkyl, such as CₙH₂ₙ₊₁, where n is 1 to 20, aryl, such as
   phenyl and substituted phenyl radicals, (CH₂)ₙ—NH₂, H
R′=alkyl, such as CₙH₂ₙ₊₁, where n is 1 to 20, aryl, such as
   phenyl and substituted phenyl radicals, (CH₂)ₙ—NH₂, H
R″=alkyl, such as CₙH₂ₙ₊₁, where n is 1 to 20, aryl, such as
   phenyl and substituted phenyl radicals, (CH₂)ₙ—NH₂,
R′″=alkyl, such as CₙH₂ₙ₊₁, where n is 1 to 20, aryl, such as phenyl and substituted phenyl radicals, (CH₂)ₙ—NH₂, H

In a preferred embodiment of the invention, HMDS (hexamethyldisilazane) can be used for imparting water repellency to the flakes.

A hydrophilic, pyrogenically prepared silicon dioxide having the following physical chemical characteristics can be used as starting material:

BET surface area: 30-400 m²/g

Tamped density: 40-200 g/l

Mean primary particle size: 5-50 nm

The invention furthermore relates to a process for the production of the hydrophobic flakes, which is characterized in that hydrophilic, pyrogenically prepared silicon dioxide is compacted to give flakes, the flakes are then optionally comminuted and are classified by sieving, the flakes are then optionally sprayed with water or a catalyst or reaction auxiliary, such as, for example, dilute acid or base solution, such as, for example, hydrochloric acid or ammonia, and then sprayed with a water repellent, the mixture is allowed to ripen at a temperature of 10 to 80° C. and is then annealed for a time of 0.5 to 8 hours at a temperature of 80 to 140° C., preferably 100 to 130° C.

The hydrophobic flakes according to the invention which comprise pyrogenically prepared silicon dioxide have the following advantages:

The flakes represent a low-dust to dust-free dosage form of the hydrophobic silicon dioxide. The flakes according to the invention are also distinguished by a substantially increased tamped density, which is associated with a small packing volume.

### EXAMPLES

The hydrophilic, pyrogenically prepared silica AEROSIL® 300 was used as starting material.

AEROSIL® 300 has the following physical chemical characteristics:

| Properties | Unit | Guide values |
|---|---|---|
| Specific surface area (BET) | m²/g | 300 ± 30 |
| Mean size of the primary particles | nm | 7 |
| Tamped density (approx. value)* | g/l | About 50 |
| based on DIN EN ISO | | |
| 787/11, August 1983 | | |
| Loss on drying* 2 h at 105° C. | % by weight | <1.5 |
| Loss on ignition 2 h at 1000° C., | % by weight | <2.0 |
| based on the dried substance (2 h | | |
| at 105° C.) | | |
| pH value 4% strength dispersion | | 3.7-4.7 |
| SiO₂ content, based on the | % by weight | >99.8 |
| ignited substance | | |

AEROSIL® 300 was compacted according to EP 1 813 574 to give flakes.

The flakes were sieved with fractionation and were classified.

The flakes were then sprayed with HMDS (hexamethyldi-silazane).

The mixture was then allowed to ripen for up to three weeks at a temperature of 10 to 50° C.

The mixture was then annealed for 5 hours at 130° C. Table 1 summarizes the production conditions. Table 2 shows the physicochemical data of the flakes obtained.

TABLE 1
Production conditions:

| | | Silane | Ripening | Ripening | Reaction | Reaction |
|---|---|---|---|---|---|---|
| | Starting | HMDS | time | temperature | time | temperature |
| Example | material | [parts] | [d] | [° C.] | [h] | [° C.] |
| 1 | AEROSIL ® 300, | 20 | 22 | 15-30 | 5 | 130 |
| | fractionated, | | | | | |
| | sieved flakes | | | | | |
| 2 | AEROSIL ® 300, | 40 | 22 | 15-30 | 5 | 130 |
| | fractionated, | | | | | |
| | sieved flakes | | | | | |

TABLE 2
The surface-modified flakes obtained which comprise
pyrogenically prepared silicon dioxide have the following
physicochemical parameters:

| | Tamped | Loss on | Loss on | | | Carbon |
|---|---|---|---|---|---|---|
| | density | drying | ignition | pH | DBP number | content |
| Example | [g/l] | [%] | [%] | DIN | [%] | [%] |
| 1 | 298 | 0.7 | 4.1 | 7.0 | 128 | 3.4 |
| 2 | 293 | 0.5 | 3.4 | 8.3 | 125 | 3.3 |

1. Flakes comprising pyrogenically prepared silicon dioxide, characterized in that the flakes are rendered water repellent after compacting.

2. Process for the production of flakes according to claim 1, characterized in that hydrophilic, pyrogenically prepared silicon dioxide is compacted to give flakes, the flakes are sprayed with a water repellent, the mixture is allowed to ripen at a temperature of 10 to 80° C. and then annealed for a time of 0.5 to 8 hours at a temperature of 80 to 140° C., preferably 100 to 130° C.

3. Use of the hydrophobic flakes comprising pyrogenically prepared silicon dioxide in natural rubber and synthetic rubber production.
